(19) United States
(12) Patent Application Publication
(10) Pub. No.: US 2024/0394134 A1
(43) Pub. Date: Nov. 28, 2024

(54) INFORMATION PROCESSING SYSTEM AND NON-TRANSITORY COMPUTER READABLE MEDIUM STORING PROGRAM

(71) Applicant: FUJIFILM Business Innovation Corp., Tokyo (JP)

(72) Inventor: Tomohisa ISHIKAWA, Kanagawa (JP)

(73) Assignee: FUJIFILM Business Innovation Corp., Tokyo (JP)

(21) Appl. No.: 18/508,264

(22) Filed: Nov. 14, 2023

(30) Foreign Application Priority Data
May 24, 2023 (JP) 2023-085651

(51) Int. Cl. G06F 11/07

(52) U.S. Cl. CPC G06F 11/0772; G06F 11/0709

(57) ABSTRACT

An information processing system includes a first apparatus, in which the first apparatus includes a first processor, and the first processor is configured to acquire second logs that are recordings related to an operation of a second apparatus communicating with the first apparatus from the second apparatus, and in a case where the second logs are not acquirable, transmit first logs that are recordings related to an operation of the first apparatus to the second apparatus.

### CROSS-REFERENCE TO RELATED APPLICATIONS

This application is based on and claims priority under 35 USC 119 from Japanese Patent Application No. 2023-085651 filed May 24, 2023.

### BACKGROUND

### (i) Technical Field

The present invention relates to an information processing system and a non-transitory computer readable medium storing a program.

### (ii) Related Art

In an information processing system including an apparatus (hereinafter, referred to as a “first apparatus”) used by a user and an apparatus (hereinafter, referred to as a “second apparatus”) communicating with the first apparatus, analysis of logs related to operations of both apparatuses may be required. For example, a case where any defect has occurred in the first apparatus during or before or after communication with the second apparatus is considered. In this case, a cause of the defect may be specified by acquiring logs of the second apparatus via the first apparatus and combining and analyzing logs of both apparatuses in the first apparatuses, instead of separately checking the operation of each of both apparatuses.

JP4600447B discloses a log collection system that collects logs related to an operation performed by a computer apparatus related to a peripheral apparatus and logs related to an operation of the peripheral apparatus and that specifies a cause of a defect which has occurred in processing executed by the computer apparatus from the collected logs.

### SUMMARY

The first apparatus may not be able to acquire the logs of the second apparatus. For example, in a case where the second apparatus does not have means for providing the logs, the logs of the first apparatus and the second apparatus cannot be combined into one and analyzed in the first apparatus. In this case, the operation of each of both apparatuses is separately checked, and problems such as requiring time or being unable to specify the cause may arise in specifying the cause in a case where, for example, the above defect has occurred.

Aspects of non-limiting embodiments of the present disclosure relate to an information processing system and a non-transitory computer readable medium storing a program that combine logs of both of a first apparatus and a second apparatus into one even in a case where the first apparatus cannot acquire the logs of the second apparatus in an information processing system including the first apparatus and the second apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a first apparatus, in which the first apparatus includes a first processor, and the first processor is configured to acquire second logs that are recordings related to an operation of a second apparatus communicating with the first apparatus from the second apparatus, and in a case where the second logs are not acquirable, transmit first logs that are recordings related to an operation of the first apparatus to the second apparatus.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system;

FIG. 2 is a block diagram illustrating a hardware configuration of the information processing system;

FIG. 3 is an image diagram of storage regions of logs;

FIG. 4 is a flowchart illustrating a flow of processing of the information processing system according to an exemplary embodiment; and

FIG. 5 is a diagram illustrating an example of a screen displaying a generation result of logs.

### DETAILED DESCRIPTION

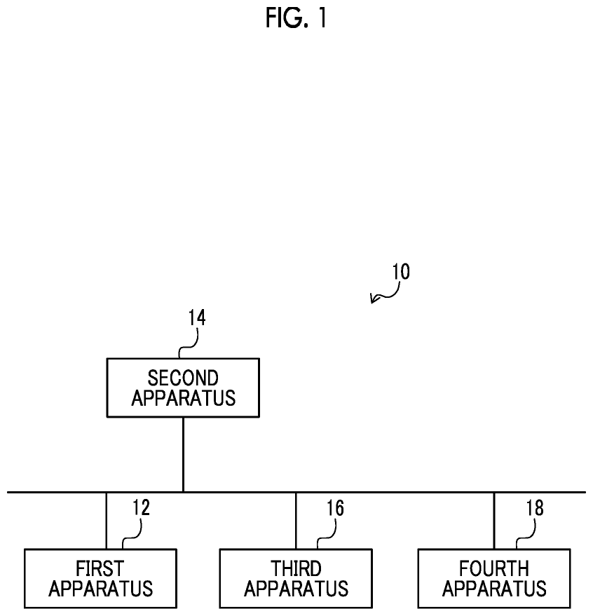

FIG. 1 is a block diagram illustrating a configuration of an information processing system. An information processing system 10 according to an exemplary embodiment is an example of the information processing system according to the exemplary embodiment of the present invention. The information processing system 10 includes, for example, a first apparatus 12, a second apparatus 14, a third apparatus 16, and a fourth apparatus 18. The first apparatus 12 to the fourth apparatus 18 communicate with each other via a communication path such as the Internet or a local area network (LAN). The first apparatus 12 to the fourth apparatus 18 are, for example, apparatuses such as a personal computer (hereinafter, referred to as a “PC”), an image processing apparatus, or a server. The image processing apparatus is an apparatus having at least one function of a scan function, a print function, or a copy function. The image processing apparatus may be a multifunction peripheral having the scan function, the print function, the copy function, and the like.

In the exemplary embodiment, the first apparatus 12 illustrated in FIG. 1 is a multifunction peripheral used by a user. The first apparatus 12 is an example of a first apparatus including a first processor according to the exemplary embodiment of the present invention.

The second apparatus 14 is a managed print service (MPS) server used for analyzing an output status of processing such as printing or scanning in each of the first apparatus 12, the third apparatus 16, and the fourth apparatus 18 and performing operation management, asset management, optimization support, and the like based on the analyzed information. In other words, the second apparatus 14 is an apparatus that manages each apparatus by acquiring management logs from the first apparatus 12, the third apparatus 16, and the fourth apparatus 18 for each predetermined period. The management logs will be described later.

The third apparatus 16 is a multifunction peripheral and is an apparatus that performs processing in cooperation with the first apparatus 12. Specifically, there is an application for performing printing or scanning via a plurality of multifunction peripherals manufactured by the identical maker in cooperation with each other, and the first apparatus 12 and the third apparatus 16 correspond to the plurality of multifunction peripherals on which the application is installed. In the above, “performing processing in cooperation” refers to a case where, for example, the user provides an output instruction for a printed matter A to a multifunction peripheral 1 and then the printed matter A can be output in another multifunction peripheral 2 (that is, the multifunction peripheral 1 and the multifunction peripheral 2 are set to be able to share a printing job). In the present example, the first apparatus 12 and the third apparatus 16 are in a relationship of apparatuses on which the application is installed to perform processing in cooperation with each other. While the first apparatus 12 and the third apparatus 16 perform processing in cooperation with each other in the present example, the present invention is not limited thereto. The first apparatus 12 used by the user and the other apparatus may separately perform processing without cooperation.

The fourth apparatus 18 is a multifunction peripheral. In the present example, the first apparatus 12 and the third apparatus 16, and the second apparatus 14 and the fourth apparatus 18 are apparatuses manufactured by different makers from each other, and makers responsible for maintenance and management are also different.

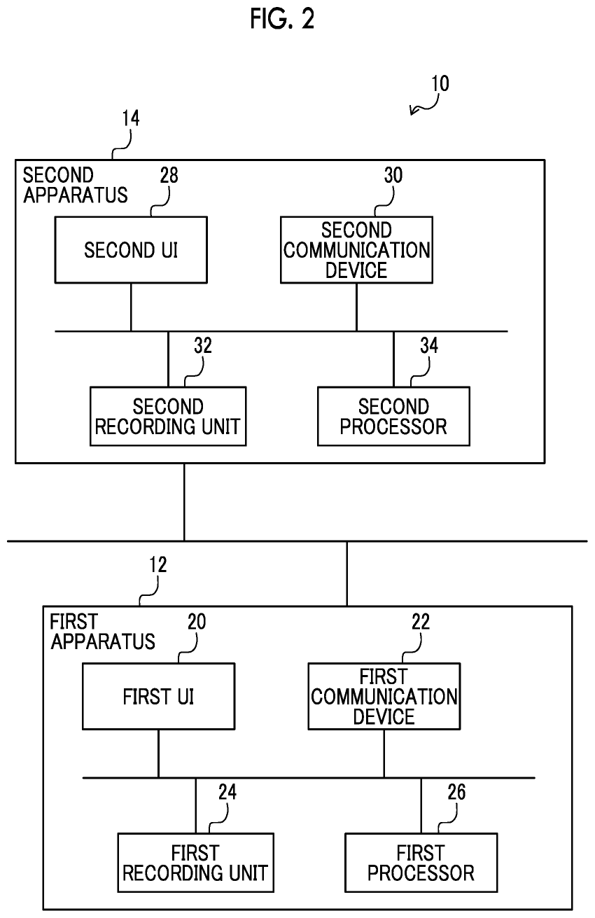

The first apparatus 12 and the second apparatus 14 will be further described. FIG. 2 is a block diagram illustrating a hardware configuration of the information processing system. While the third apparatus 16 and the fourth apparatus 18 are not illustrated in FIG. 2, the first apparatus 12 to the fourth apparatus 18 may be connected to each other via the communication path as in the configuration illustrated in FIG. 1.

The first apparatus 12 includes a first UI 20, a first communication device 22, a first recording unit 24, and a first processor 26.

The first UI 20 is a user interface and includes a display and an input device. The display is a liquid crystal display, an EL display, or the like. The input device is a keyboard, a mouse, an input key, an operation panel, or the like. The first UI 20 may be a UI such as a touch panel including both of the display and the input device.

The first communication device 22 includes one or a plurality of communication interfaces including a communication chip, a communication circuit, and the like and has a function of transmitting information to other apparatuses and a function of receiving information from other apparatuses. The first communication device 22 may have a wireless communication function such as short-range wireless communication or Wi-Fi (registered trademark) or may have a wired communication function.

The first recording unit 24 is a device constituting one or a plurality of storage regions in which data is stored. The first recording unit 24 is, for example, a hard disk drive (HDD), a solid state drive (SSD), various types of memories (for example, a RAM, a DRAM, an NVRAM, or a ROM), or other storage devices (for example, an optical disc), or a combination thereof.

The first processor 26 controls an operation of each unit of the first apparatus 12. In addition, while a series of processing in the exemplary embodiment may be performed by another system other than the information processing system 10, the first processor 26 is assumed to perform the series of processing.

The second apparatus 14 includes a second UI 28, a second communication device 30, a second recording unit 32, and a second processor 34.

The second UI 28, the second communication device 30, and the second recording unit 32 have the identical functions to the first UI 20, the first communication device 22, and the first recording unit 24, respectively.

The second processor 34 controls an operation of each unit of the second apparatus 14.

Processing performed by the first processor 26 will be further described. In a case where the user provides an instruction to generate logs via the first UI 20, the first processor 26 receives the instruction via the first communication device 22. The first processor 26 acquires second logs that are recordings related to an operation of the second apparatus 14 communicating with the first apparatus 12 of the first processor 26 from the second apparatus 14. Here, in a case where the second logs cannot be acquired, the first processor 26 transmits first logs that are recordings related to an operation of the first apparatus 12 to the second apparatus 14. Both of the first apparatus 12 and the second apparatus 14 hold respective logs of the first apparatus 12 and the second apparatus 14 in advance. That is, in the first apparatus 12, the first logs that are logs of the first apparatus 12 are extracted (that is, acquired) and recorded in the first recording unit 24 under control of the first processor 26. Similarly, in the second apparatus 14, the second logs that are logs of the second apparatus 14 are extracted and recorded in the second recording unit 32 under control of the second processor 34. That is, in a case where the first processor 26 acquires the second logs, the first processor 26 acquires the second logs from the second recording unit 32 and records the acquired second logs in the first recording unit 24. On the other hand, in a case where the first processor 26 transmits the first logs, the first processor 26 extracts the first logs from the first recording unit 24 and transmits the first logs to the second apparatus 14.

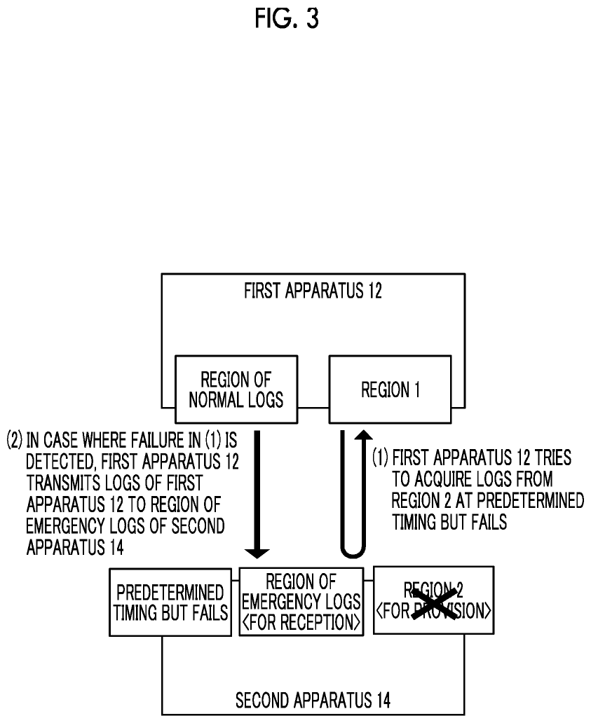

Here, the “management logs” and the “first logs” described above will be described in more detail. As described above, the management logs are logs acquired from the first apparatus 12 for each predetermined period by the second apparatus 14 managing the first apparatus 12. The management logs are logs indicating the output status of printing, scanning, or the like in the first apparatus 12 and include information for maintenance and management of the first apparatus 12. Specifically, logs in which a remaining amount of toner of the first apparatus 12, count information of the number of printed sheets in the first apparatus 12, and the like are recorded are included. On the other hand, as described above, while the “first logs” are recordings related to the operation of the first apparatus 12, the first logs are logs that are originally not assumed to be transmitted to the second apparatus 14 and that are for a developer of the first apparatus 12. That is, the “first logs” transmitted from the first apparatus 12 to the second apparatus 14 in a “case where the second logs cannot be acquired” are logs for inspection that are transmitted only in a case where a problem, a malfunction, or the like has occurred. Thus, the first logs are logs different from the “management logs” periodically acquired from the first apparatus 12. The second apparatus 14 may have a plurality of storage regions of logs. In addition, similarly, the first apparatus 12 also may have a plurality of storage regions of logs. FIG. 3 is an image diagram of the storage regions of logs. As illustrated in FIG. 3 and as described above, in a case where the second logs of the second apparatus 14 cannot be acquired, the first apparatus 12 (more specifically, the first processor 26) transmits the first logs that are recordings related to the operation of the first apparatus 12 to the second apparatus 14. At this point, a region (in FIG. 3, a region illustrated as “region of normal logs”) in which logs such as the management logs that are normally acquired are stored and another region (that is, a region of emergency logs for receiving and storing the first logs as in a case where the processing in the exemplary embodiment is performed) (in FIG. 3, a region illustrated as “region of emergency logs <for reception>”) may be separately provided in the second recording unit 32 of the second apparatus 14. With such a configuration, the emergency logs are separately managed from the management logs that are normal logs under control of the second processor 34. In FIG. 3, the second apparatus 14 also has a region 2 for provision (in FIG. 3, a region illustrated as “region 2 <for provision>”) in addition to the region of the normal logs and the region of the emergency logs for reception. In addition, the first apparatus 12 also has a region 1 for reception separately from the region of the normal logs. Furthermore, the second processor 34 may separately manage the normal logs and the emergency logs for each multifunction peripheral by providing the region of the normal logs and the region of the emergency logs for each multifunction peripheral managed by the second apparatus 14. With such a configuration, even in a case where the second apparatus 14 manages a plurality of multifunction peripherals as in the present example, logs of each multifunction peripheral are not mixed. Thus, the user can extract only required logs in the case of extracting logs, which is efficient.

Next, a specific scene in which the above processing is performed will be described. In a case where the user uses the first apparatus 12, both of the logs related to the operation of the first apparatus 12 and the logs related to the operation of the second apparatus 14 during communication with the first apparatus 12 may be required. For example, in a case where any defect has occurred in the first apparatus 12 during or before or after communication between both apparatuses, analysis of the operations of both apparatuses is required. At this point, the user tries to combine the logs related to the operations of both apparatuses into one and analyze the combined logs in the first apparatus 12 used by the user. However, the first apparatus 12 may not be able to acquire the second logs. As one of causes, the second apparatus 14 simply may not have means for providing logs to other apparatuses. In addition, the first apparatus 12 may not be able to acquire the second logs because of rules between both apparatuses. As described above, the second apparatus 14 is an MPS server and thus manages the first apparatus 12 that is a multifunction peripheral. That is, since there is a so-called main-sub relationship between the second apparatus 14 and the first apparatus 12 (that is, a relationship in which the second apparatus 14 is “main”, and the first apparatus 12 is “sub”), there is a probability that the first apparatus 12 cannot acquire the second logs because of the rules. In the present example, the series of processing in the information processing system 10 in such a scene will be described.

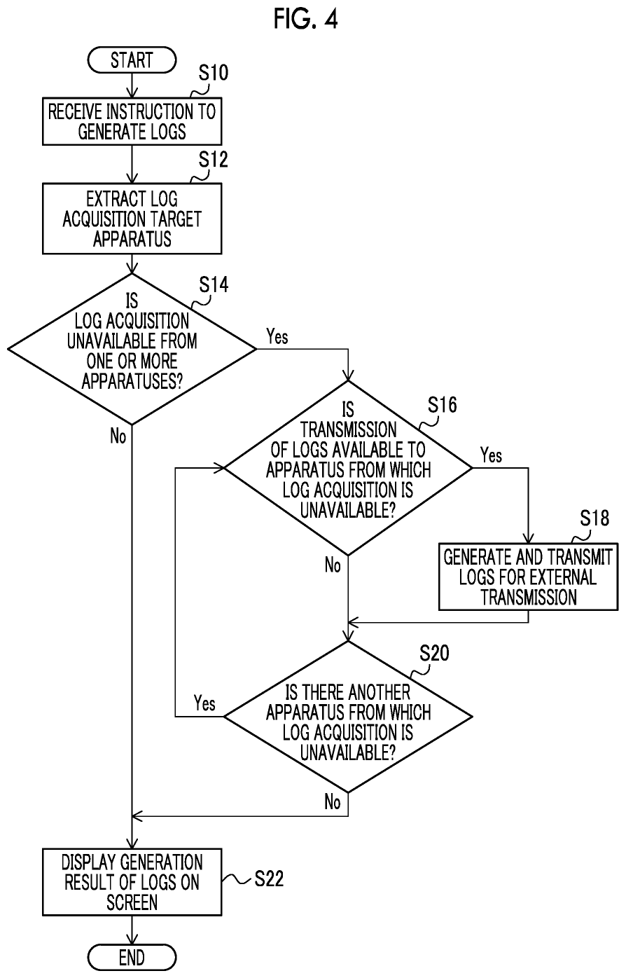

The processing according to the exemplary embodiment will be further described with reference to FIG. 4. FIG. 4 is a flowchart illustrating a flow of processing of the information processing system according to the exemplary embodiment. In the present example, a case where the first processor 26 of the first apparatus 12 acquires the second logs of the second apparatus 14 communicating with the first apparatus 12 will be illustratively described. In addition, a case where the first processor 26 acquires logs of each of the third apparatus 16 and the fourth apparatus 18 illustrated in FIG. 1 will also be described together. Here, “acquiring logs” is executing processing for acquiring logs and does not depend on whether or not acquisition has been actually performed.

The user provides the instruction to generate logs by operating the first UI 20. While the instruction to generate logs triggers execution of the series of processing in FIG. 4 in the present example, the present invention is not limited thereto. First, the first processor 26 receives the instruction to generate logs issued by the user via the first communication device 22 (S10). Next, the first processor 26 extracts an apparatus as a target for log acquisition (S12). Generally, in a case where the first apparatus 12 is installed in a company or in a store, the first apparatus 12 communicates with a large number of apparatuses in addition to the second apparatus 14 to the fourth apparatus 18 via the communication path such as the Internet. Accordingly, in the case of acquiring logs of all apparatuses communicating with the first apparatus 12, logs that are not required are also acquired, which is not efficient. Therefore, the first processor 26 extracts only an apparatus satisfying a predetermined condition as the target for log acquisition. The “apparatus satisfying the predetermined condition” is, for example, an apparatus that has communicated with the first apparatus 12 within a certain period or an apparatus that has requested or acquired information about the first apparatus 12 periodically or within a certain period. In the present example, the second apparatus 14 corresponds to the apparatus that periodically acquires the information about the first apparatus. In addition, the third apparatus 16 and the fourth apparatus 18 correspond to the apparatus that has communicated with the first apparatus 12 within a certain period (for example, within one hour after the user has provided the instruction to generate logs).

In a case where three apparatuses of the second apparatus 14 to the fourth apparatus 18 are extracted as the apparatus as the target for log acquisition, the first processor 26 acquires the logs of the three apparatuses that are recordings related to operations. The first processor 26 determines whether or not log acquisition is unavailable from one or more apparatuses (S14). In a case where log acquisition is not unavailable from one or more apparatuses (No in S14), that is, in a case where logs have been acquired in all of three apparatuses, the first processor 26 transitions the processing to step S22.

On the other hand, in a case where log acquisition is unavailable from one or more apparatuses (Yes in S14), the first processor 26 transitions the processing to step S16. The first processor 26 determines whether or not transmission of the first logs is available in order to transmit the first logs that are logs of the first apparatus 12 to the apparatus from which log acquisition is unavailable (S16). In the present example, two apparatuses of the second apparatus 14 and the fourth apparatus 18 are assumed to correspond to the “apparatus from which log acquisition is unavailable”. As in the present example, in a case where a plurality of apparatuses correspond to the apparatus from which log acquisition is unavailable, the processing is performed in order for each apparatus.

In a case where transmission of the first logs is unavailable (No in S16), the first processor 26 transitions the processing to step S20. On the other hand, in a case where transmission of the first logs is available (Yes in S16), the first processor 26 generates logs for external transmission and transmits the generated logs to the apparatus from which log acquisition is unavailable (for example, the second apparatus 14 is first set as the apparatus) (S18). Here, the logs for external transmission are logs transmitted instead of the first logs. For example, the first processor 26 may generate third logs by deleting specific information from the first logs. In this case, the third logs are the logs for external transmission. In addition, the first processor 26 may generate fourth logs by extracting a part related to an operation executed with respect to the first apparatus 12 by the second apparatus 14 from the first logs. In this case, the fourth logs are the logs for external transmission. The first logs may include personal information of the user. In addition, the first logs may include logs related to an operation that is not related to the processing performed while the first apparatus 12 communicates with other apparatuses. In addition, as described above, since the logs for external transmission are logs for inspection that are transmitted only in a case where a problem, a malfunction, or the like has occurred. Thus, logs used in inspection of only the first apparatus 12 side (that is, logs including the entire processing content performed in the first apparatus 12 as information) may not be required. Therefore, the first processor 26 newly generates the third logs or the fourth logs to narrow down the first logs to information required for analysis of logs to a certain degree.

In a case where the logs for external transmission are transmitted to the second apparatus 14, the first processor 26 next determines whether or not there is also the apparatus from which log acquisition is unavailable other than the second apparatus 14 (S20). As described above, since the fourth apparatus 18 also correspond to the apparatus from which log acquisition is unavailable (Yes in S20), the first processor 26 returns to step S16 and executes the series of processing from step S16. In a case where there is no apparatus from which log acquisition is unavailable (that is, in a case where the series of processing has been executed with respect to all apparatuses extracted in step S12 as the apparatus from which log acquisition is unavailable) (No in S20), the first processor 26 transitions the processing to step S22.

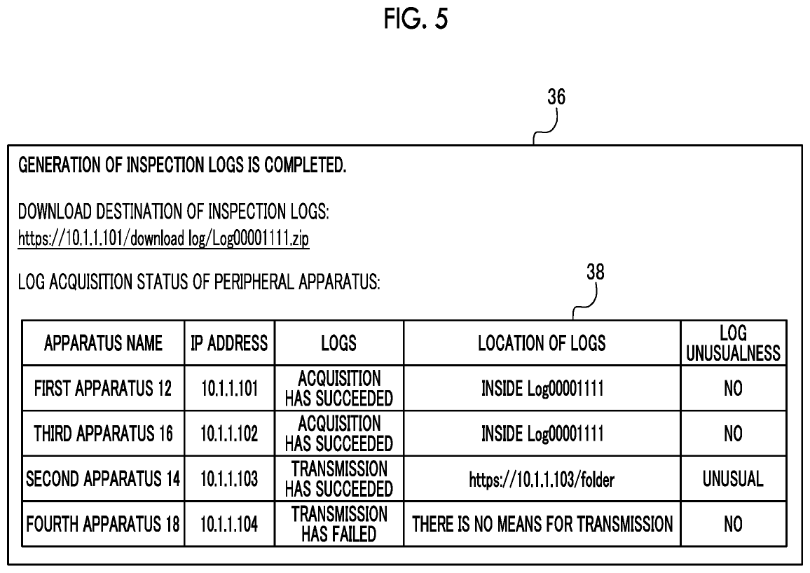

Next, the first processor 26 displays a generation result of logs on a screen (S22) and finishes the series of processing. Here, displaying the generation result of the logs refers to generating and displaying summarized information about acquisition of logs including whether or not acquisition has succeeded from the first apparatus 12 (that is, the first apparatus 12 of the first processor 26) and from all apparatuses extracted in step S12 as the target for log acquisition. An example of a display screen will be described with reference to the screen in FIG. 5.

FIG. 5 is a diagram illustrating an example of the screen displaying the generation result of logs. A screen 36 illustrated in FIG. 5 is the screen of the generation result of logs displayed on the first UI 20 of the first apparatus 12. More specifically, the screen 36 is a screen illustrating where the logs of each of the plurality of apparatuses (here, the first apparatus 12 and each of the second apparatus 14 to the fourth apparatus 18 that are apparatuses communicating with the first apparatus 12) are combined into one and stored by the series of processing of the information processing system 10 according to the exemplary embodiment described with reference to the flowchart in FIG. 4. In a case where the processing of acquiring logs performed by the first processor 26 has succeeded, the logs are stored in a location illustrated as “download destination of inspection logs” on the screen 36. That is, the logs are stored in the first recording unit 24 of the first apparatus 12.

With reference to a table 38 illustrated in FIG. 5, since the first apparatus 12 is the first apparatus 12 of the first processor 26, acquisition of the logs of the first apparatus 12 succeeds. In addition, acquisition of the logs of the third apparatus 16 also succeeds. As described above, since the first apparatus 12 and the third apparatus 16 are in a relationship of apparatuses that are apparatuses of the identical maker and that perform processing in cooperation with each other, the first apparatus 12 and the third apparatus 16 can exchange logs with each other. The first processor 26 performs the series of processing of acquiring the logs of the apparatus communicating with the first apparatus 12 and, in a case where the logs cannot be acquired, transmitting the first logs that are recordings related to the operation of the first apparatus 12. Here, since the first apparatus 12 can acquire the logs of the third apparatus 16, transmission of the first logs of the first apparatus 12 and the subsequent processing are not performed. In a case where the logs of the third apparatus 16 are acquired, the first processor 26 combines the first logs of the first apparatus 12 and the logs of the third apparatus 16 into one and stores the combined logs in “Log00001111” in the first recording unit 24.

Next, acquisition of the logs of the second apparatus 14 performed by the first processor 26 is unavailable, as described with reference to the flowchart in FIG. 4. Therefore, the first processor 26 transmits the first logs of the first apparatus 12 to the second apparatus 14. As illustrated in the table 38 in FIG. 5, transmission of the logs succeeds. Thus, the second processor 34 that receives the logs combines the first logs of the first apparatus 12 and the second logs of the second apparatus 14 into one and stores the combined logs in a folder in the second recording unit 32. Here, while an item of log unusualness of the second apparatus 14 displays “unusual” in the table 38, this will be described later.

Next, log acquisition of the fourth apparatus 18 performed by the first processor 26 also results in being unavailable. In addition, in the present example, the fourth apparatus 18 does not have means for receiving logs. Accordingly, even in a case where the first processor 26 tries to transmit the first logs of the first apparatus 12 to the fourth apparatus 18, transmission is unavailable (illustrated as “transmission failure” in the table 38). Accordingly, in a case where the logs of the first apparatus 12 and the fourth apparatus 18 cannot be combined into one, the first processor 26 informs the user by displaying an indication of the case on the first UI 20.

While the first processor 26 of the first apparatus 12 performs the series of processing of the exemplary embodiment in the above, the present invention is not limited thereto. For example, the first processor 26 and the second processor 34 may perform the series of processing in cooperation with each other. In such a case, the first apparatus 12 including the first processor 26 and the second apparatus 14 including the second processor 34 are examples of a first apparatus including a first processor and a second apparatus including a second processor, respectively, in a fifth aspect of the present invention. In a configuration in which the first processor 26 and the second processor 34 perform the processing in cooperation with each other, the first processor 26, for example, transmits the first logs to the second apparatus 14 in a case where the second logs cannot be acquired from the second apparatus 14. The second processor 34 receives the transmitted first logs. The second processor 34 executes processing of combining logs after receiving the first logs into one and storing the combined logs.

In addition, the second processor 34 may be an agent that executes other processing. For example, the second processor 34 records communication between the first apparatus 12 and the second apparatus 14 in the second recording unit 32 as history information. In addition, after the first logs are received, the second processor 34 generates log information in which the first logs and the second logs are combined into one. Then, the second processor 34 compares the history information with the generated log information and, in a case where there is an unusual part in the generated log information as a result of the comparison, displays the part separately from other parts. Here, in processing the display, the second processor 34 may perform display processing by controlling the second UI 28 or may transmit information to the first apparatus 12. In a case where the first apparatus receives the information, the first processor 26 then may perform the display processing by controlling the first UI 20. Examples of displaying the unusual part separately from the other parts include coloring the unusual part or making a text of the unusual part bold. Such display enables efficient analysis of logs. In a case where the second processor 34 performs such processing, the item of the log unusualness of the second apparatus 14 in the table 38 in FIG. 5 displays “unusual”. Accordingly, the user can more efficiently analyze logs.

The above series of processing enables the logs of both apparatuses to be combined into one even in a case where the first apparatus cannot acquire the logs of the second apparatus. In addition, transmitting only the information required for analysis of logs enables efficient analysis of logs.

The above functions of the information processing system 10 are implemented by, for example, hardware and software in cooperation with each other. For example, functions of each apparatus are implemented by reading out and executing a program stored in a memory of each apparatus via a processor. The program is stored in the memory via a recording medium such as a CD or a DVD or via a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An information processing system comprising:
a first apparatus,
wherein the first apparatus includes a first processor, and
the first processor is configured to:
   acquire second logs that are recordings related to an operation of a second apparatus communicating with the first apparatus from the second apparatus; and
   in a case where the second logs are not acquirable, transmit first logs that are recordings related to an operation of the first apparatus to the second apparatus.

(((2)))

The information processing system according to (((1))), wherein the first processor is configured to:
in a case of transmitting the first logs to the second apparatus, generate third logs by deleting specific information from the first logs and transmit the third logs instead of the first logs.

(((3)))

The information processing system according to (((1))), wherein the first processor is configured to:
in a case of transmitting the first logs to the second apparatus, extract a part related to an operation executed with respect to the first apparatus by the second apparatus from the first logs as fourth logs and transmit the fourth logs instead of the first logs.

(((4)))

The information processing system according to (((1))), wherein the first processor is configured to:
in a case where transmission of the first logs to the second apparatus fails, display an indication of the failure.

(((5)))

An information processing system comprising:
a first apparatus; and
a second apparatus that communicates with the first apparatus,
wherein the first apparatus includes a first processor,
the second apparatus includes a second processor,
the first processor is configured to:
   in a case where second logs that are recordings related to an operation of the second apparatus are not acquirable from the second apparatus, transmit first logs that are recordings related to an operation of the first apparatus to the second apparatus, and
the second processor is configured to:
   in a case where the first processor is unable to acquire the second logs, receive the first logs.

(((6)))

The information processing system according to (((5))),
wherein the second apparatus is an apparatus that manages the first apparatus by acquiring management logs from the first apparatus for each predetermined period, and
the management logs and the first logs that are transmitted to the second apparatus from the first apparatus in a case where the second logs are not acquirable are different logs.

(((7)))

The information processing system according to (((5))),
wherein the second apparatus includes a recording unit, and
the second processor is configured to:
   record communication between the first apparatus and the second apparatus in the recording unit as history information;
   after the first logs are received, generate log information in which the first logs and the second logs are combined into one; and
   compare the history information with the generated log information and, in a case where there is an unusual part in the generated log information as a result of the comparison, display the part separately from other parts.

(((8)))

A non-transitory computer readable medium storing a program causing a computer to execute a process comprising:
acquiring second logs that are recordings related to an operation of a second apparatus communicating with a first apparatus from the second apparatus in the first apparatus; and
transmitting first logs that are recordings related to an operation of the first apparatus to the second apparatus in a case where the second logs are not acquirable in the first apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first apparatus,
wherein the first apparatus includes a first processor, and
the first processor is configured to:
acquire second logs that are recordings related to an operation of a second apparatus communicating with the first apparatus from the second apparatus; and
in a case where the second logs are not acquirable, transmit first logs that are recordings related to an operation of the first apparatus to the second apparatus.

2. The information processing system according to claim 1, wherein the first processor is configured to:
in a case of transmitting the first logs to the second apparatus, generate third logs by deleting specific information from the first logs and transmit the third logs instead of the first logs.

3. The information processing system according to claim 1, wherein the first processor is configured to:
in a case of transmitting the first logs to the second apparatus, extract a part related to an operation executed with respect to the first apparatus by the second apparatus from the first logs as fourth logs and transmit the fourth logs instead of the first logs.

4. The information processing system according to claim 1, wherein the first processor is configured to:
in a case where transmission of the first logs to the second apparatus fails, display an indication of the failure.

5. An information processing system comprising:
a first apparatus; and
a second apparatus that communicates with the first apparatus,
wherein the first apparatus includes a first processor,
the second apparatus includes a second processor,
the first processor is configured to:
in a case where second logs that are recordings related to an operation of the second apparatus are not acquirable from the second apparatus, transmit first logs that are recordings related to an operation of the first apparatus to the second apparatus, and
the second processor is configured to:
in a case where the first processor is unable to acquire the second logs, receive the first logs.

6. The information processing system according to claim 5,
wherein the second apparatus is an apparatus that manages the first apparatus by acquiring management logs from the first apparatus for each predetermined period, and
the management logs and the first logs that are transmitted to the second apparatus from the first apparatus in a case where the second logs are not acquirable are different logs.

7. The information processing system according to claim 5,
wherein the second apparatus includes a recording unit, and
the second processor is configured to:
record communication between the first apparatus and the second apparatus in the recording unit as history information;
after the first logs are received, generate log information in which the first logs and the second logs are combined into one; and
compare the history information with the generated log information and, in a case where there is an unusual part in the generated log information as a result of the comparison, display the part separately from other parts.

8. A non-transitory computer readable medium storing a program causing a computer to execute a process comprising:
acquiring second logs that are recordings related to an operation of a second apparatus communicating with a first apparatus from the second apparatus in the first apparatus; and
transmitting first logs that are recordings related to an operation of the first apparatus to the second apparatus in a case where the second logs are not acquirable in the first apparatus.
